(19) United States
(12) Patent Application Publication
(10) Pub. No.: US 2022/0058491 A1
(43) Pub. Date: Feb. 24, 2022

(54) DEVICE, METHOD AND SYSTEM FOR REGULARIZATION OF A BINARY NEURAL NETWORK

(71) Applicant: HUAWEI TECHNOLOGIES CO., LTD., Shenzhen (CN)

(72) Inventors: Dmitry Yurievich IGNATOV, Moscow (RU); Alexander Nikolaevich FILIPPOV, Moscow (RU); Xueyi ZOU, Shenzhen (CN)

(21) Appl. No.: 17/520,197

(22) Filed: Nov. 5, 2021

Related U.S. Application Data
(63) Continuation of application No. PCT/RU2019/000313, filed on May 7, 2019.

(51) Int. Cl. G06N 3/08; G06N 3/04

(52) U.S. Cl. CPC G06N 3/084; G06N 3/04

(57) ABSTRACT

The present application relates to the field of neural networks, in particular Binary Neural Networks (BNN). The application proposes a device and method for regularization of a BNN. The device is configured to obtain binary weights of the BNN, and to change the binary weights of the BNN using a backpropagation method. Thereby, changing the binary weights increases or minimizes decrease of an information entropy of a weight distribution.

### CROSS-REFERENCE TO RELATED APPLICATIONS

This application is a continuation of International Application No. PCT/RU2019/000313, filed on May 7, 2019, which is hereby incorporated by reference in its entirety.

### TECHNICAL FIELD

The present disclosure relates to the field of neural networks, in particular to a Binary Neural Network (BNN). The application is concerned with the regularization of a BNN. To this end, the application propose a device and method for regularization of a BNN. The device or method can, for example, be used in a system for training a BNN.

### BACKGROUND

Modern convolutional neural networks (CNN) are used to solve a vast diversity of business tasks including image classification, object detection, sales forecasting, customer research, data validation, risk management, etc. The training of an accurate CNN is a difficult complex procedure, and is in fact the key part of success of the business projects and scientific investigations. Conventionally, L₁/L₂ penalty and weight decay are the methods used for regularization. These methods influence a weight distribution, prevent an overfitting, and provide a better generalization and higher prediction accuracy of the CNN.

Nowadays, mobile technology is rapidly evolving from simple accessories used for phone call and messaging to multi-tasking devices, which are utilized not only for navigation, internet browsing, and instant messaging, but also for such intellectual tasks as image classification, object detection, or natural language processing. These solutions require compact, low-power consuming and robust BNNs. Together with advantages like high speed, small size and limited usage of energy, the BNNs have the drawback that it is impossible to reduce their overfitting and to increase their accuracy with the usage of the conventional regularization methods. The conventional regularization methods were developed for float-point weights, and cannot impact the binary weights of the BNN, which weights are represented by two fixed numbers (for example, 1 and −1).

Thus, training of compact, robust and accurate BNNs requires new effective regularization solutions.

To develop an effective system for training a BNN, firstly, an appropriate principle of binary weights regularization needs to be selected. Then, on the basis of the selected principle, new efficient regularization solutions have to be provided for improvement of the accuracy of the BNN. The solutions should be:
Binary-oriented: to provide improvement of information capacity and prediction accuracy of the BNN;
Multi-phase: to provide several efficient approaches for BNN regularization during different phases of training;
Layer-specific: to provide efficient approaches for regularization of separate units of the BNN;
Efficient: to guaranty real-time regularization of trained BNN.

As mentioned above, L1/L2 penalty and weight decay regularization approaches are conventionally utilized.

In the field of machine learning and, particularly, in the process of artificial neural network training, regularization is a method of introducing additional information, in order to prevent an overfitting, i.e. a too close fit of prediction results to the limited set of training data points. Regularization methods can reduce overfitting, even when the quantity of training data is essentially limited. A general idea of regularization is to add an extra term to a cost function, called the regularization term or penalty. In the case of conventional L₂ regularization, such a penalty is presented by a sum of the squares of all the weights in the network, scaled by the predefined factor. In the case of conventional L₁ regularization, the absolute values of weights are utilized, instead of their squares.

Intuitively, the effect of regularization is to persuade the network to maintain smaller weights during a learning procedure. Larger weights are only allowed, if they considerably reduce the prediction error. From another point of view, regularization can be viewed as a way of compromising between finding small weights and minimizing the original cost function.

Another conventional approach is weight decay, which is a scaling of each weight by a factor (i.e. a value between zero and one) after an update of the weights. Weight decay can be decoupled from a gradient-based update, and can be executed in a training cycle separately. The utilization of conventional L₁ or L₂ penalty and weight decay is shown in FIG. 10 in a common cycle of convolutional neural network training.

However, the above described regularization methods cannot be applied to the binary weights of a BNN, due to the fact that it is impossible to decrease the absolute values of two fixed numbers, and since it does not make sense to take into account a sum of the absolute values of weights, which is constant in the case of values symmetric with respect to the zero (e.g. weights 1 and −1).

Thus, the main problem is that conventional L₁/L₂ penalties or weight decay cannot be applied for the regularization of the conventional BNN.

### SUMMARY

In view of the above-mentioned problems, embodiments of the present application aim to improve the conventional training of a BNN. An objective is to provide a regularization device and method for a BNN. Thereby, a binary-weight oriented regularization should be provided, which improves the information capacity and prediction accuracy of the BNN. Further, several different embodiments for the BNN regularization should be available, which may be efficient during different phases of training the BNN. Embodiments of the application should also cover different regularization strategies from aggressive regularization of binary weights (e.g. at the beginning of training process when the weight distribution is almost uniform), to precise, soft regularization of weights (e.g. at the end of the training, when the weight distribution can be skewed).

Further, embodiments of the application should provide efficient solutions for a regularization of separate units of the BNN, in order to insure an improvement of accuracy also in case of complex heterogeneous networks. In addition, efficient real-time regularization of the BNN should be possible. In contrast to the conventional solutions, embodiments of the application should be optimized to operate with binary weights and give better accuracy and smaller overfitting by maintaining information capacity of the binary weight distribution.

The objective is achieved by embodiments of the application as described in the enclosed independent claims. Advantageous implementations of embodiments of the application are further defined in the dependent claims.

In particular, embodiments of the application propose three approaches for the enlargement of information capacity of a BNN, according to the principle of maximum entropy:
Penalization for the loss of information entropy of a weight distribution in the BNN.
Increasing the probability of weight flips in one or more layers of the BNN with reduced information entropy of weight distribution, in particular by boosting back-propagation gradients.
Random replacements of prevalent weights with minor weights of the BNN.

A first aspect of the application provides a device for regularization of a BNN, wherein the device is configured to: obtain binary weights of the BNN; and change the binary weights of the BNN using a backpropagation method, wherein changing the binary weights increases or minimizes decrease of an information entropy of a weight distribution of the weights.

Notably, the BNN has maximum information entropy at the beginning of the training, and the information entropy may naturally decrease during the training process. However, the device of the first aspect at least minimizes this decrease of the information entropy, and in some cases can even increase it. Thereby, an information capacity and prediction accuracy of the BNN are significantly improved. Consequently, the device provides an efficient regularization method for the BNN.

In an implementation form of the first aspect, the backpropagation method includes a backpropagation of error gradients obtained during training of the BNN.

In an implementation form of the first aspect, the device is configured to: change the binary weights of the BNN separately for at least one filter or layer of the BNN.

Thus, regularization is possible for separate units of the BNN, which ensures improvement of accuracy also in case of complex heterogeneous networks.

In an implementation form of the first aspect, the device is configured to: change the binary weights of the BNN in real-time during training of the BNN.

In an implementation form of the first aspect, the device is configured to change the binary weights of the BNN by: randomly replacing, for one or more layers of the BNN, at least one prevalent weight by a minority weight.

This provides a direct increase of the information capacity within the one or more layers, and thus a simple approach. The approach is particularly suitable for the beginning of the training.

In an implementation form of the first aspect, the device is configured to change the binary weights of the BNN by: determining a weight distribution for each of a plurality of layers of the BNN, determining, per layer of the plurality of layers, an information entropy based on the determined weight distribution, and increasing a backpropagation gradient for each layer of the plurality of layers, for which an information entropy is determined below a certain threshold value.

Boosting the backpropagation gradients can be used for accurate maintaining of information capacity during different phases of the training, particularly in the middle. The boosting of the gradients increases the probability of weight flips.

In an implementation form of the first aspect, the device is configured to: increase the backpropagation gradient for a given layer by a value that is proportional to the loss of information entropy in the following layer of the BNN.

In an implementation form of the first aspect, the device is configured to change the binary weights of the BNN by: determining one or more weight distributions for one or more layers and/or filters of the BNN, or determining a weight distribution for the entire BNN, determining an information entropy based on each determined weight distribution, and appending a cost function, used for training the BNN, with a penalty term based on the one or more determined information entropies.

This approach is well suitable to be applied for the entire training of the BNN. This approach is the most natural and soft way to increase, maintain, or minimize decrease of the information capacity of the BNN.

In an implementation form of the first aspect, the device is configured to: determine an information loss based on the one or more determined information entropies, and append the information loss as the penalty term to the cost function.

In an implementation form of the first aspect, the device is configured to: determine the information loss with respect to a maximum information entropy of the one or more weight distributions, or with respect to a constant value.

A second aspect of the application provides a system for training a BNN, the system comprising: a training device to obtain and train the BNN, and a device according to the first aspect or any of its implementation forms.

Thus, the training system can apply either one or any combination of methods described above, in order to increase, maintain, or minimize decrease of the information capacity of the BNN. It thus enjoys the advantages described above.

In an implementation form of the second aspect, the device according to the first aspect or any of its implementation forms is included in the training device and/or in an updating device, wherein: the training device is configured to change the binary weights of the BNN by: determining one or more weight distributions for one or more layers and/or filters of the BNN, or determining a weight distribution for the entire BNN, determining an information entropy based on each determined weight distribution, and appending a cost function, used for training the BNN, with a penalty term based on the one or more determine information entropies; the updating device is configured to change the binary weights of the BNN by at least one of: randomly replacing at least one prevalent weight by a minority weight; determining a weight distribution of weights for each of a plurality of layers of the BNN, determining, per layer of the plurality of layers, an information entropy based on the determined weight distribution, and increasing a backpropagation gradient for each layer, for which an information entropy is determined below a certain threshold value.

In an implementation form of the second aspect, the system comprises further at least one of a terminal device configured to provide the BNN to the training device; a prediction device configured to provide a prediction result based on trained data produced by the BNN and received from the training device; a data storage configured to store the BNN and/or training data and/or the trained data.

A third aspect of the application provides a method for regularization of a BNN, wherein the method comprises: obtaining binary weights of the BNN; and changing the binary weights of the BNN using a backpropagation method, wherein changing the binary weights increases or minimizes decrease of an information entropy of a weight distribution of the weights.

The method of the third aspect can have implementation forms that correspond to the implementation forms of the device of the first aspect. Accordingly, the method of the third aspect achieves all the advantages and effects described above for the device of the first aspect.

A fourth aspect of the application provides a computer program product comprising a program code for controlling a device according to the first aspect or any of its implementation forms, or for controlling a system according to the second aspect or any of its implementation forms, or for carrying out, when implemented on a processor, the method according to the third aspect.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms of the present application will be explained in the following description of specific embodiments in relation to the enclosed drawings, in which

FIG. 1 shows a device for regularization of a BNN according to an embodiment of the application.

FIG. 2 shows a general method for regularization of a BNN according to an embodiment of the application.

FIG. 3 shows a method for increasing or minimizing decrease of information capacity of a BNN based on information loss penalty.

FIG. 4 shows a method for increasing or minimizing decrease of information capacity of a BNN in layers with large information entropy loss.

FIG. 5 shows a method for increasing or minimizing decrease of information capacity in a layer of the BNN by weight replacement.

FIG. 6 shows a device according to an embodiment of the application implementing different schemes for maintaining or increasing information capacity of a BNN in a common training cycle.

FIG. 7 shows a system for training a BNN according to an embodiment of the application.

FIG. 8 shows a system for training a BNN according to an embodiment of the application.

FIG. 9 shows an example of automatic image segmentation with a BNN.

FIG. 10 shows a common cycle of convolutional neural network training.

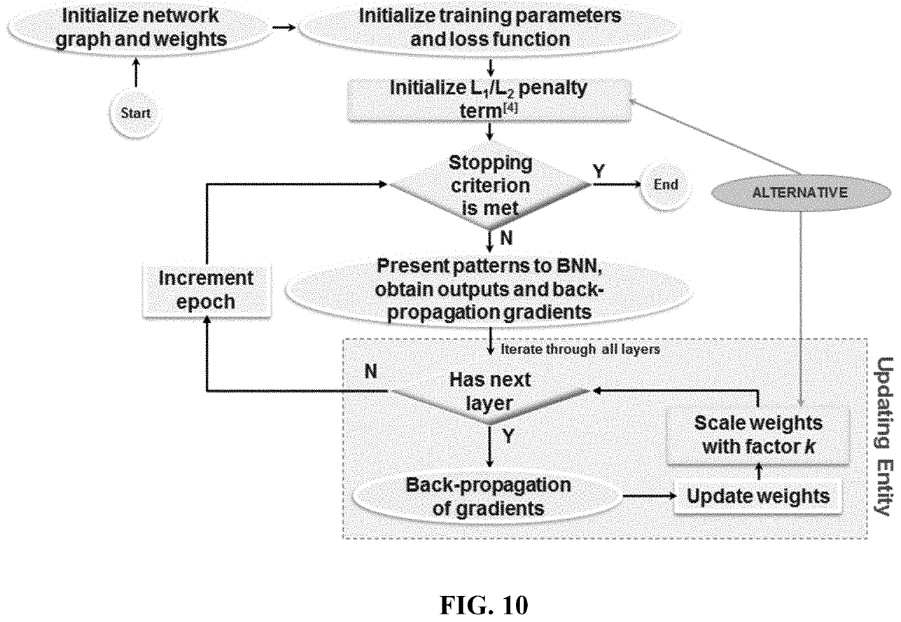

### DETAILED DESCRIPTION OF EMBODIMENTS

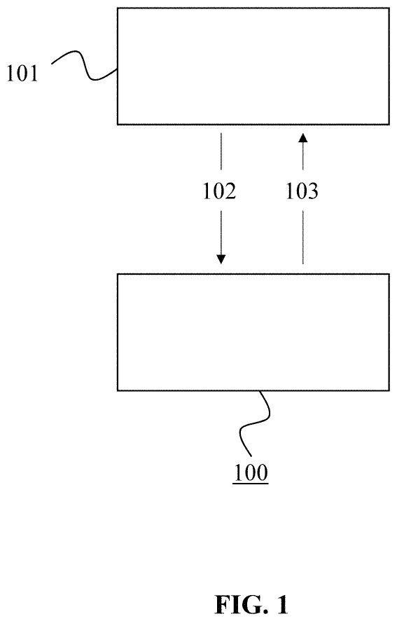

FIG. 1 shows a device 100 according to an embodiment of the application. The device 100 is configured to perform a regularization or to control a regularization of a BNN 101. The device may be implemented in a training unit and/or an updating unit of a system for training the BNN 101. The device 100 may comprise processing circuitry (not shown) configured to perform, conduct or initiate the various operations of the device 100 described herein. The processing circuitry may comprise hardware and software. The hardware may comprise analog circuitry or digital circuitry, or both analog and digital circuitry. The digital circuitry may comprise components such as application-specific integrated circuits (ASICs), field-programmable gate arrays (FPGAs), digital signal processors (DSPs), or multi-purpose processors. In one embodiment, the processing circuitry comprises one or more processors and a non-transitory memory connected to the one or more processors. The non-transitory memory may carry executable program code which, when executed by the one or more processors, causes the device 100 to perform, conduct or initiate the operations or methods described herein.

The device 100 is configured to obtain binary weights 102 of the BNN 101, e.g. to receive them from a training unit, or to determine them based on analyzing the BNN 101. Further, the device 100 is configured to change the binary weights 102 of the BNN 101 using a backpropagation method 103. The back propagation method 103 can be based on a conventional backpropagation method 103, and may include a backpropagation of error gradients obtained during the training of the BNN 101. The device 100 is in particular configured to change the binary weights 102 of the BNN 101 such, that an information entropy of a weight distribution of the weights 102 is increased, is maintained, or at least a decrease of the information entropy is minimized.

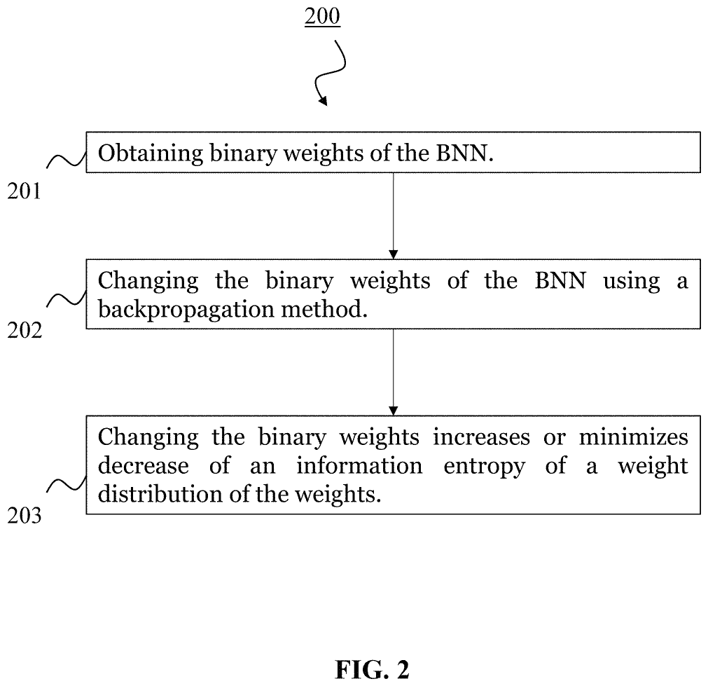

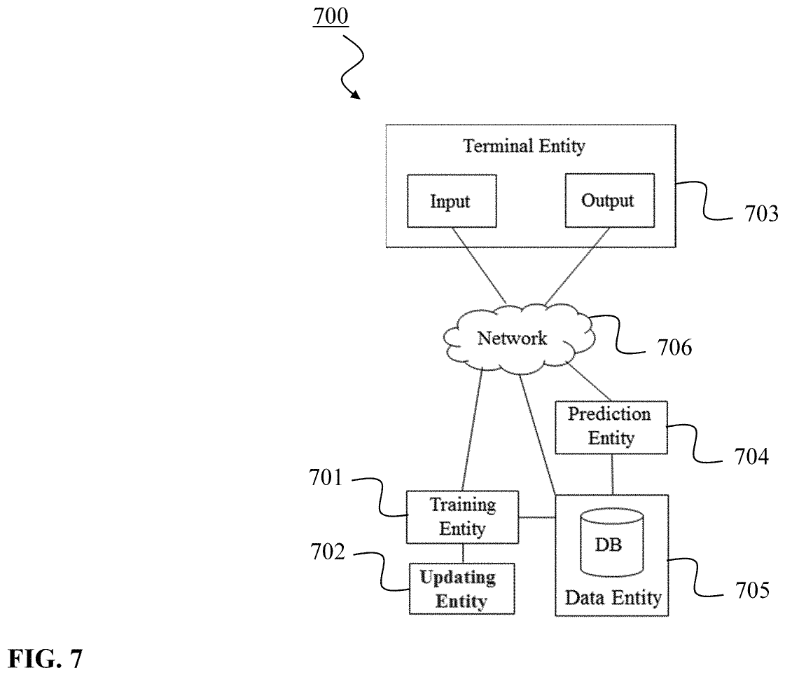

FIG. 2 shows a method 200 according to an embodiment of the application. The method 200 is for regularization of a BNN 101 and may be performed by the device 100 shown in FIG. 1 (or by a system 700 as shown in FIG. 7). The method 200 comprises: obtaining 201 binary weights 102 of the BNN 101; and changing 202 the binary weights 102 of the BNN 101 using a backpropagation method 103. The changing 202 of the binary weights 102 increases or minimizes decrease of 203 an information entropy of a weight distribution of the weights 102.

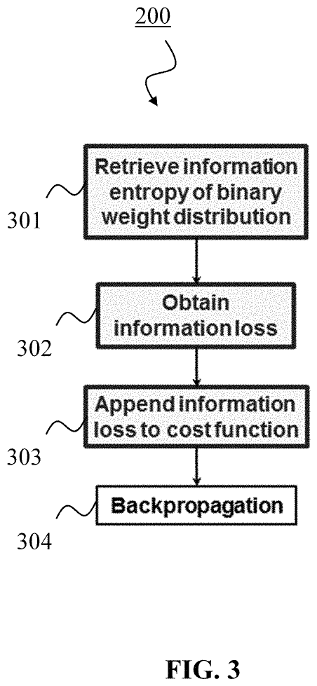

FIG. 3 shows an approach of increasing or minimizing the decrease of the information capacity of the BNN 101—with the device 100 of FIG. 1 or method 200 of FIG. 2—by using information loss penalty.

Due to the fact that existing regularization methods cannot impact the distribution of binary weights, the device 100 and method 200 according to embodiments of the application base on the principle of maximum entropy. According to the principle of maximum entropy, the probability distribution that best represents the current state of knowledge is the one with the largest information entropy. In compliance with the definition of information entropy, the higher its value the higher the potential quantity of information in the system. To simplify the following description, the term “information capacity” is used to represent the potential quantity of information in a BNN 101.

For maintaining of the larger information capacity (higher informational entropy) of the BNN 101, a penalty for the loss of information entropy may be used. This relatively simple approach for increasing the information capacity (or minimizing its decrease) may include four steps as are shown in FIG. 3.
1. The approach starts from the retrieval 301 of information entropy for binary weight 102 distribution of the BNN 101. Information entropy can be obtained for the full network (BNN 101), or for every unit of the network (i.e., for instance, per layer, filter of the BNN 101).
2. Then, the information loss is obtained 302 as a loss of information entropy of the binary weight 102 distribution with respect to the maximum information entropy of the binary distribution (preferably from a theoretical point of view), or with respect to any constant value. If the information losses are obtained for separate elements of the BNN 101, then the total information loss may be computed as a sum of losses.
3. The information loss is appended 303 to a cost function as a penalty for the reduction of the information capacity of the BNN 101.
4. Any known backpropagation method 103 can then be applied 304 for the training of the BNN 101 with the usage of the proposed penalty.

As an example, a feasible numerical implementation of this approach for increasing the information capacity of the BNN 101 is now presented.

Information entropy for binary weights ϵ{1, −1} of the network can be represented as:

$$H = - ( \frac{N - {\sum }_{n = 1}^{N} {w}_{n}}{2 N} * log 2 \frac{N - {\sum }_{n = 1}^{N} {w}_{n}}{2 N} + \frac{N + {\sum }_{n = 1}^{N} {w}_{n}}{2 N} * log 2 \frac{N + {\sum }_{n = 1}^{N} {w}_{n}}{2 N} ) ,$$

wherein N is the number of weights, wₙ is a value of a weight with index n.

A scalable value of information loss can be represented as:

I_{Loss}=k*(Hₘₐₓ−H),

wherein k is a predefined constant and Hₘₐₓ is a maximum information entropy, which is equal to 1 in the case of a binary distribution.

The penalty may be appended to a cost function in standard way:

Cost function=Loss+I_{Loss′}

The appending of a penalty to a cost function is a rather common approach for regularization of an artificial neural network. Thus, usage of information loss penalty is considered as the most natural and soft way of information capacity maintaining in a BNN 101. This approach can be applied alone, for maintaining information capacity during all training procedure(s), or can cover only part of a training process, and can be utilized together with the other approaches described in the following.

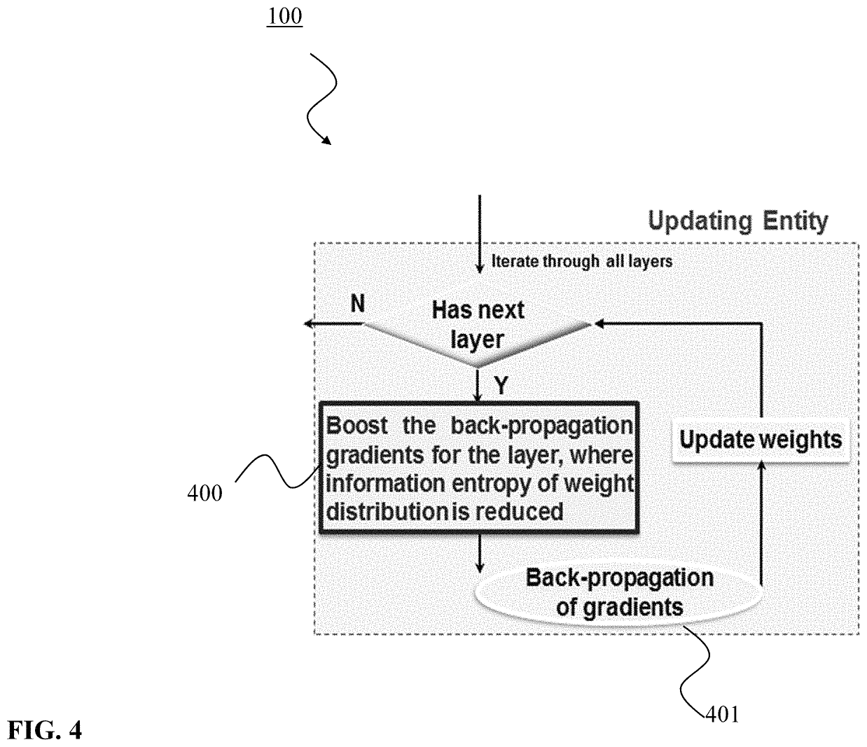

FIG. 4 shows another approach of increasing or minimizing decrease of information capacity of a BNN 101—with the device 100 of FIG. 1 or the method 200 of FIG. 2—in layers with large information entropy loss. In particular, the heuristic approach includes boosting 400 back-propagation gradients 401 for certain layers, where the information entropy of the weight distribution is reduced, particularly below a certain threshold value. Increasing the gradient values enhances the probability of weight flips in these layers with low information entropy of the weight distribution, and thus leads to a more uniform distribution of the binary weights 102.

This approach can be implemented as an enlargement of the back-propagation gradients 401 by a value proportional to the loss of information entropy in the layer. An example of a feasible numerical implementation of this approach is:

gradients*=I+Iₗₒₛₛ,

wherein gradients is a tensor of back-propagation gradients 401.

This approach is applicable for the accurate maintaining of information capacity during different phases of the network training, especially in the middle of the training process.

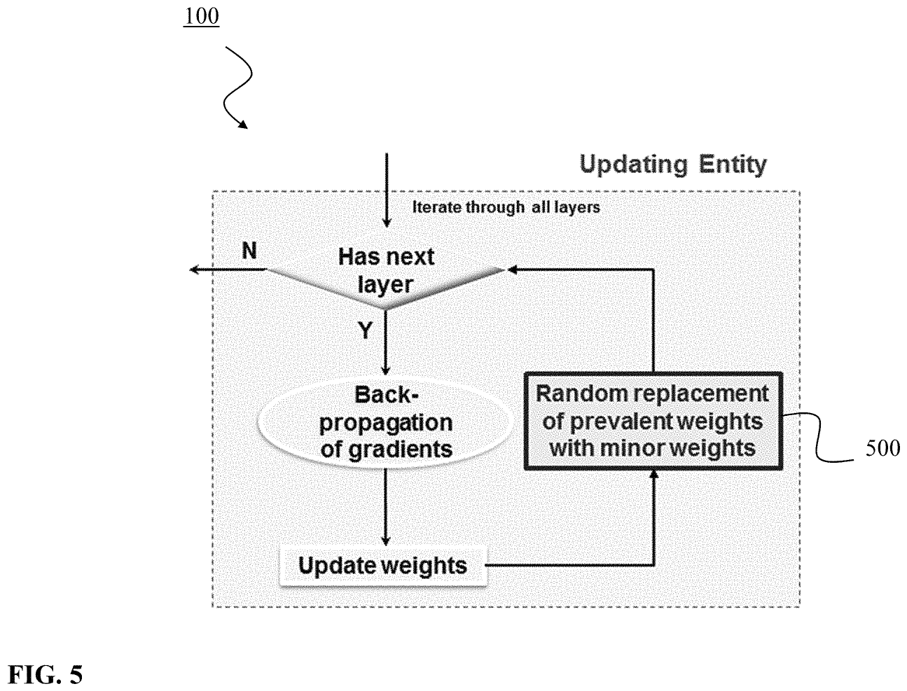

FIG. 5 shows another approach of increasing or minimizing decrease of information capacity in a layer of the BNN 101—with the device 100 of FIG. 1 or the method 200 of FIG. 2—by weight replacement, i.e. in a direct manner. The largest information entropy corresponds to the uniform distribution of values (here the binary weights 102). To maintain uniform distribution of the binary weights 102, a random replacement 500 of prevalent weights with minor weights can be employed, supporting in such way the information capacity of the BNN 101.

For example, a feasible numerical implementation can be represented as a random flip of prevalent weights in amount:

N=k*|wₙ−wₚ|/2,

wherein 0<k<1; wₙ and wₚ are quantities of negative and positive weights, respectively.

This rough approach can be used at the beginning of the training, when randomly initialized weights have almost uniform distribution, or during any other phase of binary network training.

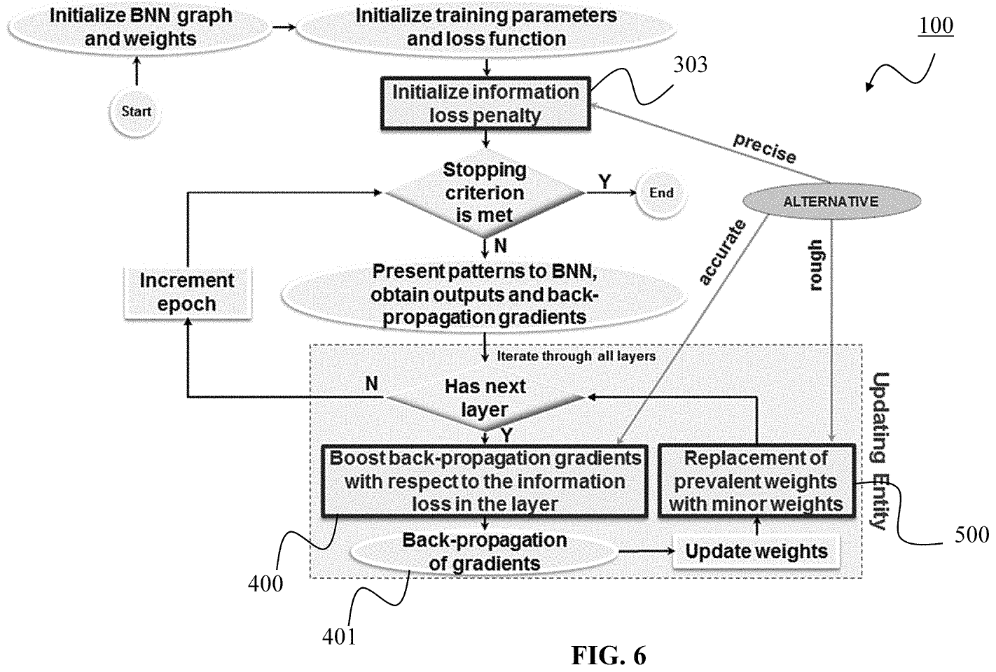

FIG. 6 shows a device 100 according to an embodiment of the application, which is configured to implement different approaches for maintaining or increasing information capacity of a BNN 101 in a common training cycle. In particular, the three above-proposed approaches for increasing or minimizing decrease of the information capacity of the BNN 101 are employed by the device 100 in the common cycle of network training.

As an input, the configuration of a network graph can be taken, in addition with training parameters, as well as an initializing method. The following steps may then be performed by the device 100:

1. Generation of network graph on the basis of input configuration.
2. Preparation of binary weights 102 with the input initializing method.
3. Training of the BNN 101 until a stopping criterion is met:
a. Present input patterns, obtain output values and back-propagation gradients 401.
b. Update the weights 102 of the BNN 101 with the backpropagation method 103, increasing an information entropy of the binary weights 102 with at least one of the three approaches:
   Appending 303 to the cost function the penalty term, e.g. loss of information entropy of binary weight distribution;
   Boosting 400 the back-propagation gradients 401 for the layers with reduced information entropy of weight distribution;
   Increasing 400 the back-propagation gradients 401 by the value proportional to the loss of information entropy in the following layer;
   Randomly replacing 500 prevalent weights 102 with minor weights 102.

FIG. 7 shows a system 700 according to an embodiment of the application. The system 700 bases on the above-described device 100 and method 200, respectively, and in particular the various approaches for increasing or minimizing decrease of the information capacity of the BNN 101. The system 700 may include the following entities (or units):
1. A Terminal Entity 703 for providing the BNN 101 to a Training Entity 701, receiving the BNN 101 from a Data Entity 705 and/or results of prediction from a Prediction Entity 704. The Terminal Entity 703 may be connected to the Training Entity 701, the Data Entity 705 and/or the Prediction Entity 704 via a network/cloud 706, e.g. computer network. That is, the BNN 101 and/or results of prediction may be exchanged over the network/cloud 706. The BNN 101 may also reside or be trained in the network/cloud 706.
2. The Training Entity 701 for controlling a training cycle: checking stopping criterion, calculating loss and sends/receives BNN 101 to/from an Updating Entity 700, sending trained BNN 101 to Data Entity 705 and receiving trained data from Data Entity 705.
3. The Updating Entity 700 for updating the BNN 101 weights 102 increasing the information entropy of weight distribution (with one of the proposed approaches) and sending the BNN 101 back to the Training Entity 701. This entity 700 may implement all three approaches for regularization of the BNN 101. One or more of the approaches may, however, also be performed by the Training Entity 701, in particular the appending 303 of the penalty term to the cost function. The Updating Entity 700 and the Training Entity 701 be included in one entity, or may be one common entity.
4. The Data Entity 705 for saving the BNN 101 form the Training or Terminal Entity 701/703, and training/testing data from the Terminal Entity 703, providing training data and/or BNN 101 to Training Entity 701, providing testing data and/or BNN 101 to Prediction Entity 704.
5. Prediction Entity 704 for receiving tested data and BNN 101 from Terminal or Data Entity 703/705, and providing prediction results for Terminal Entity 703.

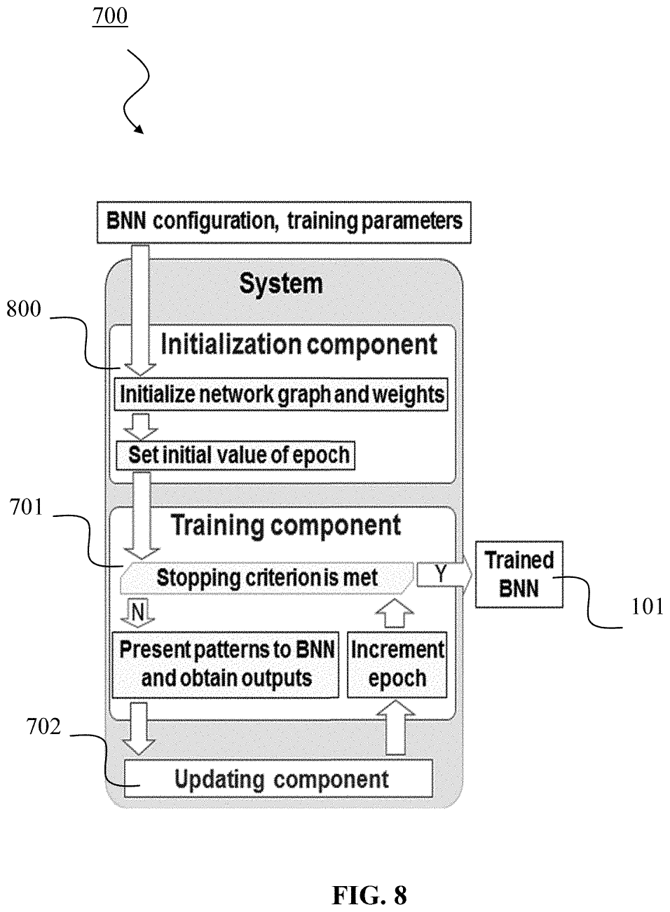

FIG. 8 shows a system 700 according to an embodiment of the application, which may build on the system 700 shown in FIG. 7. That is, the system 700 of FIG. 8 can be implemented as a system maintaining the information capacity of binary neural network as in FIG. 7. In particular, the system 700 is for maintaining the information capacity of a BNN 101.

This system 700 may include the following components (or entities/units):
1. Initialization component/entity 800 to initialize a network graph, weights 102, and epoch value.
2. Training component/entity 701 to control the training cycle.
3. Updating component/entity 702 to update weights 102 with increasing of information capacity of BNN 101.

Relationships between the components/entities of the system 700 may be:
1. Initialization component 800 sends BNN 101 and training parameter to Training component 701.
2. Training component 701 sends BNN 101 outputs and network itself to Updating Component 702, and receives BNN 101 with updated weights 102 from Updating Component 702.
3. Updating component 702 receives BNN 101 outputs and network itself from Training component 701, and sends updated BNN 101 to Training component 701.

Based on the general specification of the device 100, method 200, and system 700 given above, now their details will be described. It is thereby considered that for a concrete prediction task the configuration of the network graph needs to be specified, training parameters (i.e. learning rate and momentum) need to be chosen, an initializing method (i.e. random generator of binary values) needs to be performed, and a training dataset has to be available.
Step 1: On the basis of input network configuration, the computational graph of the BNN 101 is generated.
Step 2: An initializing method is applied for generation of the weights 102 in every element (layer/filter) of the BNN 101. For initialization a random generator of binary values can be utilized, or more sophisticated approaches, which can define the speed of convergence at the beginning of network training.
Step 3: Training of the BNN 101 is performed, until a stopping criterion is met (number of iteration is acceded, desired level of accuracy is achieved) e.g. in the following way. From the training dataset, a batch of the input patterns is selected and corresponded to expected values of outputs. Then, the input patterns are presented to the BNN 101, forward calculations are executed, and the prediction values are obtained as an output of the BNN 101. The output values are utilized for the training of the BNN 101 with the back-propagation method 103, which has at least one of improvement for the support of information capacity of the BNN 101:
   1. The cost function of back-propagation method 103 is enriched 303 with a penalty term for the loss of information entropy of weight distribution in the entire BNN 101, or with a sum of losses of information entropy of weight distribution in all functional elements (i.e. filters, separate layers or blocks of layers) of the BNN 101.
   2. The back-propagated gradients 401 are boosted 400 before the layers with reduced information entropy of weight distribution. This may be performed discreetly, i.e. for the layers, where a ratio between predominant and minority binary weights is higher than predefined threshold; or continuously, i.e. by increasing 400 the back-propagation gradients 401 for every layer by the value proportional to the loss of information entropy in it.
   3. Prevalent weights 102 are randomly replaced with minor weights 102, until a stopping criterion is met. As a stopping criterion, the equilibrium between a quantity of weights 102 of two types in the entire BNN 101 or in every functional element (i.e. filter, separate layer or block of layers) of the network can be considered. Alternatively, an achievement of a predefined threshold for the ratio between quantities of predominant and minor weights 102 in the entire BNN 101, or in every functional element (i.e. filter, separate layer or block of layers) of network.

With reference to FIG. 7, the system 700 can e.g. maintain the information capacity of the BNN 101 during its training, e.g. in the network/cloud 706, as it is described below. Before the start of the training process, loaded as an input data are the training/testing datasets via the terminal entity 703, and are saved into the database/file system of the data entity 705. Then, provided as an input data are the configuration of the BNN 101 together with training parameters, and the training cycle is launched on the training entity 701. During every iteration of the training cycle, the training entity 701 updates binary weights 102 of the BNN 101 with usage of the updating entity 702. The last one uses the back-propagation method 103 (e.g. Adam optimizer) together with at least one of the approaches for maintaining the informational capacity of the BNN 101, reducing, in such way, the overfitting and increasing the accuracy of the trained network. During the training procedure the BNN 101 is regularly saved to the data entity 705 after passing the predefined number of interactions. The trained neural network 101 can be retrieved from the data entity 705 as an output object via the terminal entity 703, or can be used inside the system 700 for the prediction, which is performed by prediction entity 704.

Examples of applications to business tasks are presented below. Generally, the device 100, method 200 and system 700 for increasing the information capacity, accuracy and reduction of overfitting, are applicable to the wide variety of modern BNNs 101 in the following domains:
Computer vision, including but not limited to the scene reconstruction, event detection, video tracking, object recognition, motion estimation, image restoration; object classification, recognition, localization, detection, or segmentation; semantic segmentation, content-based image retrieval, optical character recognition, facial recognition, shape recognition technology, motion analysis, scene reconstruction, image pre-processing, feature extraction, image-understanding, 2D code reading, 2D and 3D pose estimation.
Natural language processing, including but not limited to the grammar induction, lemmatization, morphological segmentation, part-of-speech tagging, parsing, sentence boundary disambiguation, word segmentation, terminology extraction, lexical semantics, machine translation, named entity recognition, natural language generation, natural language understanding, optical character recognition, question answering, recognizing textual entailment, relationship extraction, sentiment analysis, topic segmentation and recognition, word sense disambiguation, automatic summarization, conference resolution, discourse analysis, speech recognition, speech segmentation, text-to-speech processing, e-mail spam filtering.
System identification and control, including but not limited to the vehicle control, trajectory prediction, process control, natural resource management.
Recommendation systems.
Data mining.
Game playing.
Financial fraud detection and automated trading systems.
Medical diagnosis and drug discovery.
Customer relationship management and social network filtering.

A first example is the training of a BNN 101 with high information capacity for the enhancement of images of e.g. fashion models on digital photos.

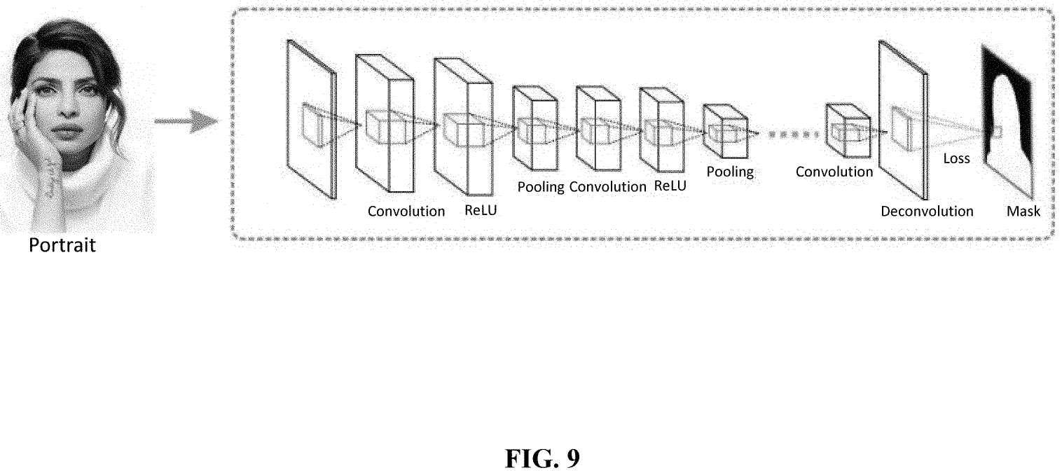

Let us consider a utilization in the process of image enhancement for the portfolio of fashion models (see FIG. 9). The peculiarities of employing the system 700 for training the BNN 101 with high information capacity and appropriate accuracy for image stylization task, consists of two steps—automatic image segmentation and improvement of the quality of fashion model image on the digital photo. Steps that do not operate with process-specific data are skipped.

The process-specific input of the system 700 for maintaining of information capacity of BNN 101 is represented by the training dataset with images of the fashion models and actual binary mask for every image. The binary mask has white color pixels corresponding to the fashion model itself and black color pixels corresponding to the background objects. The configuration of a binary convolutional neural network 101 is represented by autoencoder consisting of 35 layers with SqueezeNet as its backbone architecture. Training process is performed on GeForce GTX Titan GPUs during 10000 epoch with the usage of PyTorch framework (Torch-based open-source machine learning library for Python), and the trained network is retrieved as an output of the system 700.

The BNN 101 runs on a mobile devices. This network 101 takes as an input a digital photo of fashion model, generates the binary mask, which is utilized for the increasing of sharpness and brightness of a model image on the digital photo and for blurring of the background objects. As a result of maintaining the information capacity the trained binary neural network 101 provides portfolio images, which are indistinguishable from portfolio images provided by full-precision 32-bit neural network, while the improvement of portfolio image quality takes 32 time less memory, and works several times faster with low-power consumption.

A second example is the training of a BNN 101 with high information capacity for answering the biochemical questions.

Biochemical question answering is a domain-specific task within the fields of information retrieval and natural language processing. The structured set of texts (passages with questions and answers) for the training of binary neural network 101 and database of knowledge are retrieved by the professional biochemists from biochemical vocabularies, handbooks and Wikipedia pages. The process-specific input of apparatus for maintaining of information capacity of binary neural network includes the training data—set of passages with questions and answers. The configuration of binary convolutional neural network can be represented by the QANet network, where all convolutions are binarized. The maximum answer length may be set to 30. The pre-trained 300-D GLoVe word vectors may utilized. Training process is performed on GeForce GTX Titan GPUs during 300000 epoch with the usage of TensorFlow framework (an open-source software library for dataflow and differentiable programming across a range of tasks). The BNN 101 is retrieved as an output of the system 700.

The question answering device (a domain-specific vertical application) is generated by the field-programmable gate array technology, and utilizes the prepared knowledge database for retrieval of correct answers. The created device helps interns in development of their competence during the probation period in biochemical laboratories, and provides quick tips for professionals working on a new biochemical investigations. The maintaining of information capacity of BNN 101 during its training results in effective device, which works several times faster than full-precision version and demonstrates low-power consumption.

A third example is the training of a BNN 101 with high information capacity for control of self-driving taxi cars.

A self-driving taxi car is a vehicle capable of sensing its environment and moving without human input. Potential benefits of usage of the self-driving taxi car include reduced costs, increased safety and mobility, increased customer satisfaction and reduced crime.

The process-specific input of the system 700 for maintaining of information capacity of the BNN 101 includes the training data—images from front-facing cameras, data from radar, LIDAR, and ultrasonic sensors of car coupled with the time-synchronized speed of traveling and steering angle recorded from a human driver. The configuration of a binary convolutional neural network is represented with PilotNet-based architecture for self-driving system, where all convolutions and fully connected layers are binarized. Training process is performed on GeForce GTX Titan GPUs during 5000 epoch with the usage of PyTorch framework. The network is retrieved as an output of the system 700.

The BNN 101 runs under a Linux-based Robot Operating System providing real time taxi car driving and controls the travel speed and steering angle. The maintaining of information capacity during the training procedure results in the network that effectively controls driving process. BNN 101 works several times faster comparing to a full-precision version of network with the same architecture. The quick response to the changing traffic and appearing obstacles can be critical for the safety of passengers, especially on highway, as well as for the life of pedestrians.

In summary, embodiments of the application increase the prediction accuracy of a BNN 101 due to the enlargement of its information capacity. In particular, embodiments minimize a loss of accuracy after pruning of the BNN 101 due to the partial restoration of its information capacity. Further, the embodiments reduce the overfitting due to the learning of more general patterns.

The present application has been described in conjunction with various embodiments as examples as well as implementations. However, other variations can be understood and effected by those persons skilled in the art and practicing the claimed application, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. Device (100) for regularization of a Binary Neural Network, BNN (101), wherein the device (100) is configured to:
obtain binary weights (102) of the BNN (101); and
change the binary weights (102) of the BNN (101) using a backpropagation method (103),
wherein changing the binary weights (102) increases or minimizes decrease of an information entropy of a weight distribution of the weights (102).

2. Device (100) according to claim 1, wherein:
the backpropagation method (103) includes a backpropagation of error gradients (401) obtained during training of the BNN (101).

3. Device (100) according to claim 1, configured to:
change the binary weights (102) of the BNN (101) separately for at least one filter or layer of the BNN (101).

4. Device (100) according to the claim 1, configured to:
change the binary weights (102) of the BNN (101) in real-time during training of the BNN (101).

5. Device (100) according to the claim 1, configured to change the binary weights (102) of the BNN (101) by:
randomly replacing (500), for one or more layers of the BNN (101), at least one prevalent weight (102) by a minority weight (102).

6. Device (100) according to the claim 1, configured to change the binary weights (102) of the BNN (101) by:
determining a weight distribution for each of a plurality of layers of the BNN,
determining, per layer of the plurality of layers, an information entropy based on the determined weight distribution, and
increasing (400) a backpropagation gradient (401) for each layer of the plurality of layers, for which an information entropy is determined below a certain threshold value.

7. Device (100) according to claim 6, configured to:
increase (400) the backpropagation gradient (401) for a given layer by a value that is proportional to the loss of information entropy in the following layer of the BNN (101).

8. Device (100) according to the claim 1, configured to change the binary weights (102) of the BNN (101) by:
determining one or more weight distributions for one or more layers and/or filters of the BNN (101), or determining a weight distribution for the entire BNN (101),
determining (301) an information entropy based on each determined weight distribution, and
appending (303) a cost function, used for training the BNN (101), with a penalty term based on the one or more determined information entropies.

9. Device (100) according to claim 8, configured to:
determine (302) an information loss based on the one or more determined information entropies, and
append (303) the information loss as the penalty term to the cost function.

10. Device (100) according to claim 9, configured to:
determine (302) the information loss with respect to a maximum information entropy of the one or more weight distributions, or with respect to a constant value.

11. System (700) for training a BNN (101), the system (700) comprising:
a training device (701) to obtain and train the BNN (101), and
a device (100) according to the claim 1.

12. System (700) according to claim 11, wherein the device (100) is included in the training device (701) and/or in an updating device (702), wherein:
the training device (701) is configured to change the binary weights (101) of the BNN (102) by:
determining one or more weight distributions for one or more layers and/or filters of the BNN (101), or determining a weight distribution for the entire BNN (101),
determining (301) an information entropy based on each determined weight distribution, and
appending (303) a cost function, used for training the BNN (101), with a penalty term based on the one or more determined information entropies;
the updating device (702) is configured to change the binary weights (102) of the BNN (101) by at least one of:
randomly replacing (500) at least one prevalent weight (102) by a minority weight (102);
determining a weight distribution of weights for each of a plurality of layers of the BNN (101),
determining, per layer of the plurality of layers, an information entropy based on the determined weight distribution, and
increasing (400) a backpropagation gradient (401) for each layer, for which an information entropy is determined below a certain threshold value.

13. System (700) according to claim 12, further comprising at least one of:
a terminal device (703) configured to provide the BNN (101) to the training device (701);
a prediction device (704) configured to provide a prediction result based on trained data produced by the BNN (101) and received from the training device (701);
a data storage (705) configured to store the BNN (101) and/or training data and/or the trained data.

14. Method (200) for regularization of a Binary Neural Network, BNN (101), wherein the method (200) comprises:
obtaining (201) binary weights (102) of the BNN (101); and
changing (202) the binary weights (102) of the BNN (101) using a backpropagation method (103),
wherein changing (202) the binary weights (102) increases or minimizes decrease of (203) an information entropy of a weight distribution of the weights (102).

15. Computer program product comprising a program code for controlling a device (100) when implemented on a processor, the method (200) according to claim 14.
